(19) United States
(12) Patent Application Publication
(10) Pub. No.: US 2006/0112939 A1
(43) Pub. Date: Jun. 1, 2006

(54) Auxiliary intake device for engine

(76) Inventor: Fu-Chung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/998,731

(22) Filed: Nov. 30, 2004

(51) Int. Cl. F02B 33/40; F02D 9/02

(52) U.S. Cl. 123/565; 123/585

(57) ABSTRACT

An auxiliary intake device for an engine includes a bypass tube and a control valve mounted on the bypass tube. The bypass tube includes a first end connected to an air cleaner and a second end connected to an intake tube at a position between an intake manifold and a throttle that is mounted in an intake tube between the air cleaner and the intake manifold. The control valve is closed when a speed of an engine is below a predetermined value. The control valve is opened when the speed of the engine is equal to or greater than the predetermined value, allowing additional air from the air cleaner to enter the manifold via the bypass tube and the control valve. An air intake system for an engine with the auxiliary intake device is also provided.

### BACKGROUND OF THE INVENTION

1. Field of the Invention

The present invention relates to an air intake system for an engine. In particular, the present invention relates to an air intake system for an internal combustion engine. The present invention also relates to an auxiliary intake device of the air intake system for an engine.

2. Description of the Related Art

A typical internal combustion engine generates power by combusting air-fuel mixture in a combustion chamber in each cylinder. Reciprocating motion of a piston in the respective cylinder drives a drive shaft to thereby turn the wheels of an automobile with the engine. The air-fuel ratio is one of the important factors of smooth operation of the engine. The theoretical ideal air-fuel ratio is about 17:1. However, the actual air-fuel ratio varies in response to the speed of the engine. It is therefore the goal of the designers in the art to obtain the optimum air-fuel ratio at different speeds.

Generally, fresh air is introduced into the combustion chamber during the downward stroke of the piston, which results in a vacuum to suck ambient air into the cylinder. However, the intake valve(s) is(are) closed before sufficient air enters the combustion chamber when the engine exceeds a certain speed. The higher the speed of the engine is, the poor the volume efficiency is. A solution to solve this problem is to forcibly introduce fresh air into the combustion chamber to increase the pressure in the combustion chamber. By this arrangement, more power is output, as more air is introduced into the combustion chamber. There are two approaches for boosting the pressure in the combustion chamber: mechanical boosting and turbo boosting. The power source for mechanical boosting is the power from the engine itself, resulting in a burden to the engine. The power source for turbo boosting uses the exhaust gas after combustion, which results in a lag in the operation (known as turbo lag).

### SUMMARY OF THE INVENTION

An objective of the present invention is to provide an auxiliary intake device and an air intake system, allowing the engine to output higher power at higher speeds.

Another objective of the present invention is to provide an air intake system that allows instant boosting of the pressure in each cylinder of the engine.

In accordance with an aspect of the invention, an auxiliary intake device for an engine is provided and comprises a bypass tube and a control valve mounted on the bypass tube. The bypass tube includes a first end connected to an air cleaner and a second end connected to an intake tube at a position between an intake manifold and a throttle that is mounted in an intake tube between the air cleaner and the intake manifold. The control valve is closed when a speed of an engine is below a predetermined value. The control valve is opened when the speed of the engine is equal to or greater than the predetermined value, allowing additional air from the air cleaner to enter the manifold via the bypass tube and the control valve.

In accordance with another aspect of the invention, an air intake system for an engine is provided and comprises an air cleaner, an intake manifold, an intake tube mounted between the air cleaner and the intake manifold, a bypass tube including a first end connected to the air cleaner and a second end connected to the intake tube at a position between the intake manifold and a throttle mounted in the intake tube, and a control valve mounted on the bypass tube. The control valve is closed when a speed of an engine is below a predetermined value. The control valve is opened when the speed of the engine is equal to or greater than the predetermined value, allowing additional air from the air cleaner to enter the manifold via the bypass tube and the control valve.

The control valve may be an electromagnetic valve. A fan motor may be provided for driving air into the manifold. Preferably, the fan motor is mounted on the bypass tube.

Preferably, the control valve further includes an adjusting member for adjusting an amount of the additional air entering the manifold.

Preferably, a switch is connected between an accelerator pedal and the control valve. The switch is activated to open the control valve when the accelerator pedal is depressed through a predetermined distance. Preferably, a relay is mounted between the switch and the control valve and electrically connected to a power source. Alternatively, the switch is mounted adjacent to an accelerator rod. The switch is activated to open the control valve when the accelerator rod is moved through a predetermined distance.

Other objectives, advantages, and novel features of the invention will become more apparent from the following detailed description when taken in conjunction with the accompanying drawings.

### BRIEF DESCRIPTION OF THE DRAWINGS

FIG. 1 is a schematic view of an air intake system for an engine in accordance with the present invention.

FIG. 2 is an enlarged view of an auxiliary intake device of the air intake system in accordance with the present invention.

FIG. 3 is a view similar to FIG. 1, illustrating airflow of the air intake system when the engine runs idly or at a low speed.

FIG. 4 is a view similar to FIG. 2, illustrating airflow of the air intake system when the engine runs at a high speed.

FIG. 5 is a view similar to FIG. 3, illustrating airflow of the air intake system when the engine runs at a high speed.

### DETAILED DESCRIPTION OF THE PREFERRED EMBODIMENT

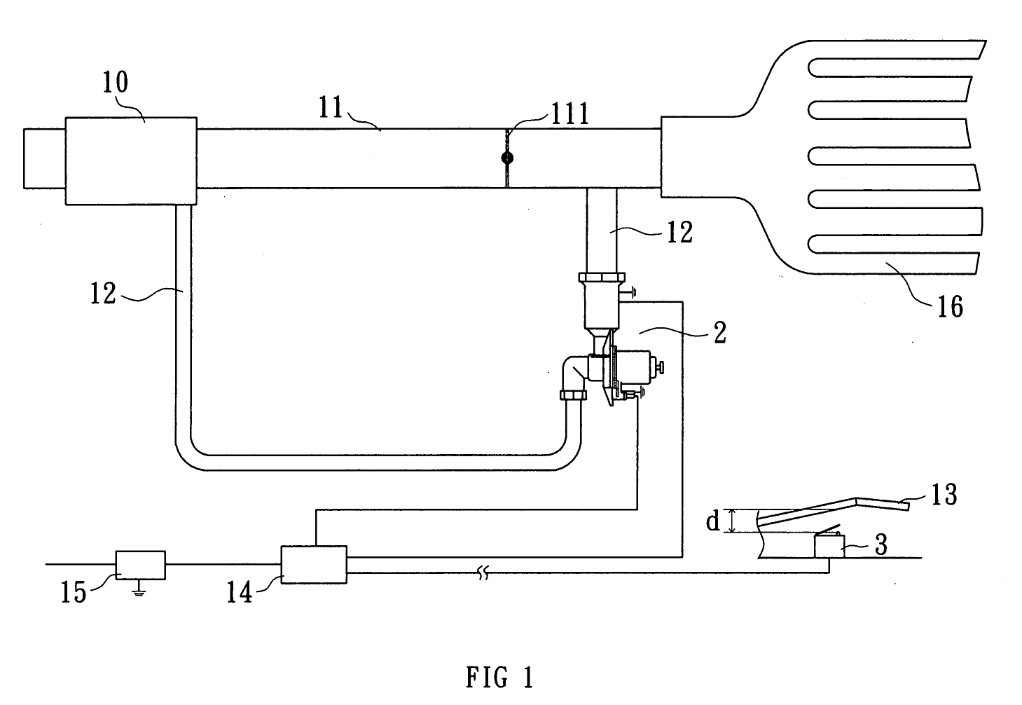

Referring to FIG. 1, an air intake system for an engine in accordance with the present invention comprises an air cleaner 10, an intake manifold 16, and an intake tube 11 connected between the air cleaner 10 and the intake manifold 16. A throttle 111 is mounted in the intake tube 11. The air intake system further comprises an auxiliary intake device that comprises a control valve means 2 mounted on a bypass tube 12 including a first end connected to the air cleaner 10 and a second end connected to the intake tube 11 at a position between the throttle 111 and the intake manifold 16.

As illustrated in FIG. 1, the control valve means 2 is connected to a relay 14. In the illustrated embodiment, the relay 14 comprises a first contact electrically connected to a power source 15 and a second contact electrically connected to the control valve means 2. Further, the relay 14 is electrically connected to a switch 3. The switch 3 is activated when an accelerator pedal 13 is depressed through a predetermined distance “d”. In this embodiment, it is set that the speed of the engine reaches a value in a range between 1000 to 2000 rpm when the accelerator pedal 13 is depressed through the predetermined distance “d”. The power source 15 may be an electric gasoline pump of an automobile.

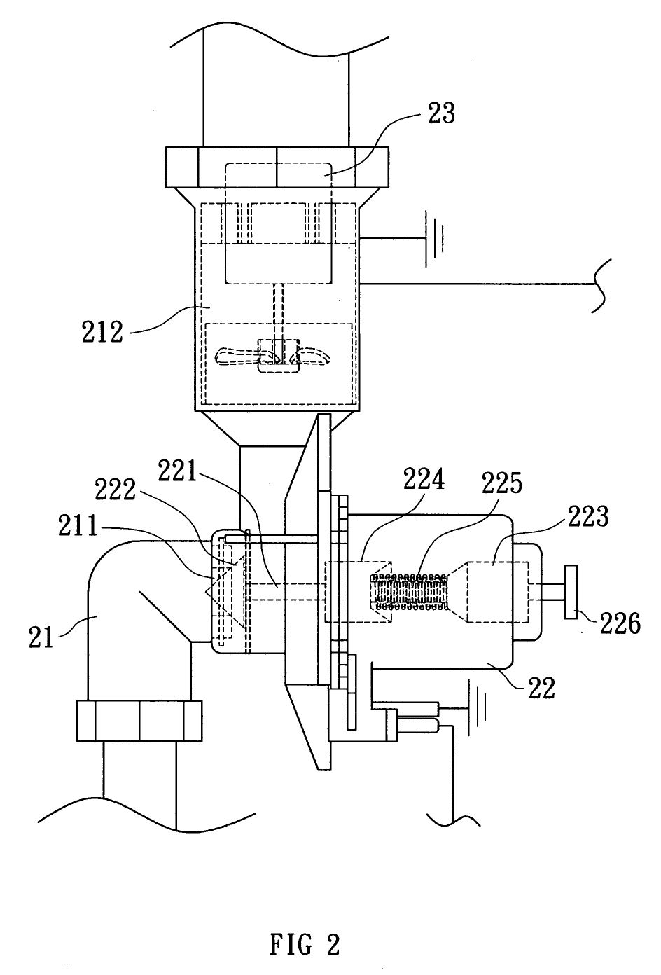

Still referring to FIG. 1 and further to FIG. 2, the control valve means 2 comprises a coupler 21 coupled with the bypass tube 12, a control valve 22, and a fan motor 23. The control valve 22 may be an electromagnetic valve mounted on an inlet side of the coupler 21. The control valve 22 comprises a stem 221 including a first end on which a plug 222 is provided 221 for sealing an inlet 211 of the coupler 21. The stem 221 further includes a magnetic end 223. A block 224 is provided an intermediate portion of the stem 221, with an elastic element 225 mounted between the block 224 and the magnetic end 223 of the stem 221. The control valve 22 further includes an adjusting member 226 mounted to the magnetic end 223, allowing adjustment in a gap between the plug 22 and a peripheral wall delimiting the inlet 211 of the coupler 21. The fan motor 23 is mounted on an outlet 212 of the coupler 21 and electrically connected to a third contact of the relay 14.

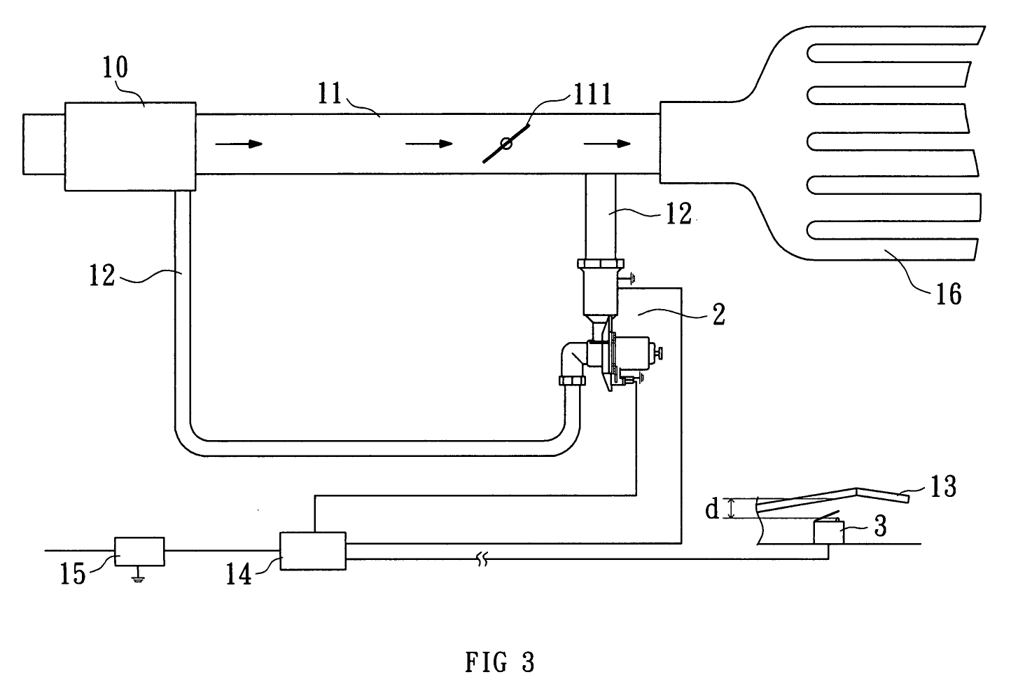

Referring to FIG. 3, when the engine runs idly or at a low speed, the plug 222 of the control valve 22 is biased by the elastic element 225 to block the inlet 211 of the coupler 21. Thus, air from the air cleaner 10 enters the manifold 16 via the inlet tube 11 after passing through the throttle valve 111, as indicated by the arrows in FIG. 3. No air will enter the manifold via the bypass tube 12. The air fuel ratio is optimal for idling and low-speed operation in which the speed of the engine is lower than the predetermined speed (such as 1500 rpm).

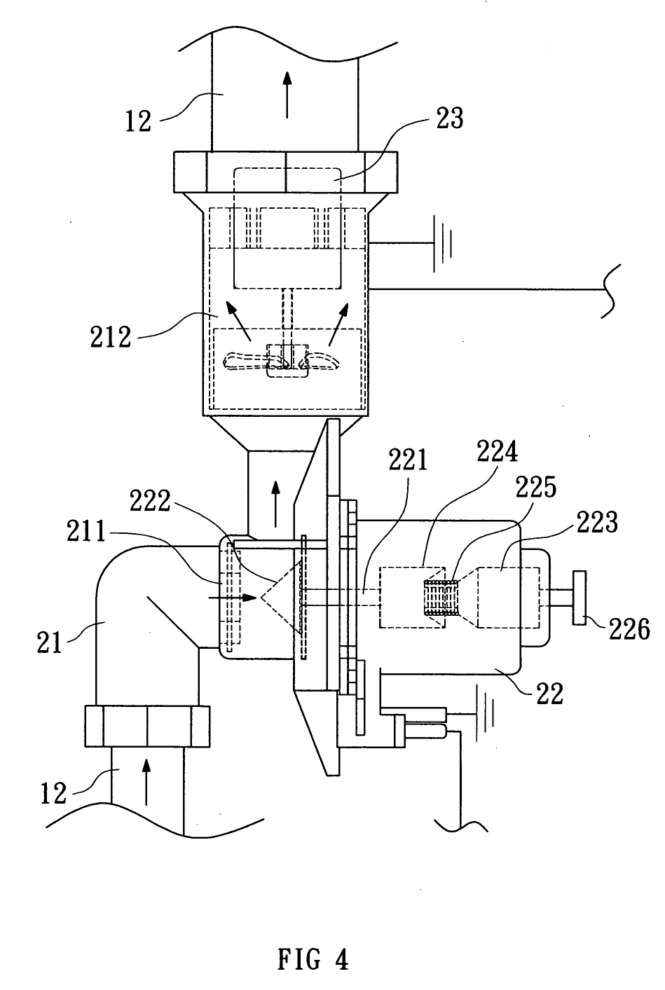

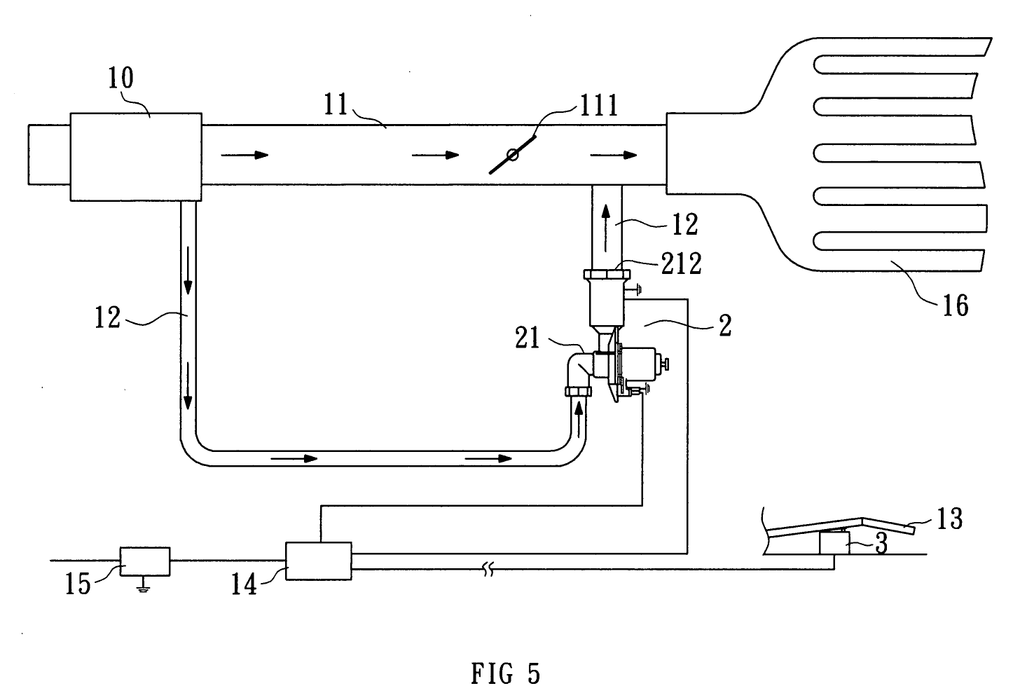

Referring to FIG. 5, when the accelerator pedal 13 is pressed through a distance not smaller than the predetermined distance “s”, the engine speed is greater than the predetermined speed. Meanwhile, the accelerator pedal 13 comes to a position in contact with and thus activates the switch 3. The relay 14 is activated to move the plug 222 of the stem 221 away from the inlet 211 of the coupler 21. Thus, the inlet 211 of the coupler 21 is no longer blocked, as shown in FIG. 4. Further, the fan motor 23 is activated to turn. In addition to the air passing through the throttle 11 to the manifold 16, additional air from the air cleaner 10 is driven into the manifold 16 via the bypass tube 12 under the action of the fan motor 23, as indicated by the arrows shown in FIGS. 4 and 5. Thus, the air-fuel ratio is increased when the engine speed is higher, providing more power in instant response to the depression of the accelerator pedal 13. Instant boosting of the pressure in each cylinder of the engine is achieved. Optimal air-fuel ratio at high engine speed is thus obtained. The output power of the engine is thus increased.

Adjustment of the adjusting member 226 of the control valve 22 allows the gap between the plug 222 of the stem 221 and the peripheral wall delimiting the inlet 211 of the coupler 21 to be adjusted, controlling the amount of fresh air passing through the inlet 211 of the coupler 21 and preventing intake of excessive additional fresh air.

The switch 3 may be activated by an accelerator rod (not shown) connected to and driven by the accelerator pedal 13. In other words, the control valve 22 is opened when the accelerator rod is moved through a predetermined distance.

Although specific embodiments have been illustrated and described, numerous modifications and variations are still possible without departing from the essence of the invention. The scope of the invention is limited by the accompanying claims.

What is claimed is:

1. An auxiliary intake device for an engine, comprising:
a bypass tube including a first end adapted to be connected to an air cleaner and a second end adapted to be connected to an intake tube at a position between an intake manifold and a throttle that is mounted in an intake tube between the air cleaner and the intake manifold; and
a control valve mounted on the bypass tube, the control valve being closed when a speed of an engine is below a predetermined value, the control valve being opened when the speed of the engine is equal to or greater than the predetermined value, allowing additional air from the air cleaner to enter the manifold via the bypass tube and the control valve.

2. The auxiliary intake device for an engine as claimed in claim 1 wherein the control valve is an electromagnetic valve.

3. The auxiliary intake device for an engine as claimed in claim 1 further comprising a fan motor for driving air into the manifold.

4. The auxiliary intake device for an engine as claimed in claim 3 wherein the fan motor is mounted on the bypass tube.

5. The auxiliary intake device for an engine as claimed in claim 1 wherein the control valve further including an adjusting member for adjusting an amount of said additional air entering the manifold.

6. The auxiliary intake device for an engine as claimed in claim 1 further comprising a switch connected between an accelerator pedal and the control valve, the switch being activated to open the control valve when the accelerator pedal is depressed through a predetermined distance.

7. The auxiliary intake device for an engine as claimed in claim 6 further comprising a relay mounted between the switch and the control valve.

8. The auxiliary intake device for an engine as claimed in claim 7 further comprising a power source electrically connected to the relay.

9. The auxiliary intake device for an engine as claimed in claim 1 further comprising a switch adapted to be mounted adjacent to an accelerator rod, the switch being activated to open the control valve when the accelerator rod is moved through a predetermined distance.

10. An air intake system for an engine, comprising:
an air cleaner;
an intake manifold;
an intake tube mounted between the air cleaner and the intake manifold, a throttle being mounted in the intake tube;
a bypass tube including a first end connected to the air cleaner and a second end connected to the intake tube at a position between the throttle and the intake manifold; and
a control valve mounted on the bypass tube, the control valve being closed when a speed of an engine is below a predetermined value, the control valve being opened when the speed of the engine is equal to or greater than the predetermined value, allowing additional air from the air cleaner to enter the manifold via the bypass tube and the control valve.

11. The air intake system for an engine as claimed in claim 10 wherein the control valve is an electromagnetic valve.

12. The air intake system for an engine as claimed in claim 10 further comprising a fan motor for driving air into the manifold.

13. The air intake system for an engine as claimed in claim 12 wherein the fan motor is mounted on the bypass tube.

14. The air intake system for an engine as claimed in claim 10 wherein the control valve further including an adjusting member for adjusting an amount of said additional air entering the manifold.

15. The air intake system for an engine as claimed in claim 10 further comprising a switch connected between an accelerator pedal and the control valve, the switch being activated to open the control valve when the accelerator pedal is depressed through a predetermined distance.

16. The air intake system for an engine as claimed in claim 15 further comprising a relay mounted between the switch and the control valve.

17. The air intake system for an engine as claimed in claim 16 further comprising a power source electrically connected to the relay.

18. The air intake system for an engine as claimed in claim 10 further comprising a switch adapted to be mounted adjacent to an accelerator rod, the switch being activated to open the control valve when the accelerator rod is moved through a predetermined distance.
